(19) United States
(12) Patent Application Publication
(10) Pub. No.: US 2015/0368874 A1
(43) Pub. Date: Dec. 24, 2015

(54) MACHINE ELECTRIC DRIVE SYSTEM

(71) Applicant: Caterpillar Inc., Peoria, IL (US)

(72) Inventors: Nicholas D. Weaver, Oswego, IL (US); Francisco Acevedo, Elgin, IL (US); Jason T. Posl, Yorkville, IL (US); Mark D. Anderson, Aurora, IL (US); Joshua W. Dorothy, Dunlap, IL (US)

(21) Appl. No.: 14/309,955

(22) Filed: Jun. 20, 2014

(51) Int. Cl. E02F 9/08; E02F 3/28; B60K 6/20

(52) U.S. Cl. CPC E02F 9/0883; B60K 6/20; E02F 3/283; Y10S 903/902

(57) ABSTRACT

A machine is provided. The machine includes a frame and an engine provided on the frame. The machine includes a generator drivably coupled to the engine. The machine includes an inverter communicably connected to the generator. The machine also includes an electric motor communicably connected to the inverter. The machine further includes a tank coupled to the frame. The tank includes at least one face and is configured to receive the inverter thereon.

### TECHNICAL FIELD

The present disclosure relates to a power system of a machine, and more specifically to an electric drive system of the machine.

### BACKGROUND

Machines powered by an engine are generally fitted with an electric drive system to increase an efficiency of the machine. The electric drive system may employ one or more components such as, an electric generator, an inverter, an electric motor, and other such sources of power. The components may require to be installed within the machine along with other existing components of the machine such as, the engine, other electrical/electronic systems, a transmission system, an emission control system, a fluid delivery system, and other such systems. These components may be housed within an enclosure of the machine.

Generally, due to space constraints in the enclosure, limited space may be provided for installation of any additional components, for example, the electric drive system, within the enclosure. In such a situation, in order to accommodate the electric drive system, overall dimensions of the enclosure may be increased to create additional space within the enclosure. These dimensional changes may affect an overall size of the machine and may also include additional costs and time associated therewith.

Hence, there is a need for an improved system design to accommodate the electric drive system on the machine.

U.S. Pat. No. 8,474,560 describes a work machine having a frame and a front and rear wheel axle. The work machine includes a cab coupled to the frame. The cab is configured to include controls for controlling the operation of the work machine. The work machine includes an electrically powered drive assembly coupled to the frame and front and rear axles. The work machine also includes an inverter electrically coupled to the electrically powered drive assembly. The work machine further includes a platform assembly disposed adjacent the cab and coupled to the frame. The platform assembly includes an outer wall and forming a compartment that is sized to receive only the inverter such that the outer wall at least partially surrounds the inverter.

### SUMMARY OF THE DISCLOSURE

In one aspect of the present disclosure, a machine is provided. The machine includes a frame and an engine provided on the frame. The machine includes a generator drivably coupled to the engine. The machine includes an inverter communicably connected to the generator. The machine also includes an electric motor communicably connected to the inverter. The machine further includes a tank coupled to the frame. The tank includes at least one face and is configured to receive the inverter thereon.

In another aspect of the present disclosure, a wheel loader powered by an electric drive system is provided. The wheel loader includes a frame and an implement coupled to the frame. The wheel loader includes an engine provided on the frame. The wheel loader includes a generator drivably coupled to the engine. The wheel loader includes an inverter communicably connected to the generator. The wheel loader includes an electric motor communicably connected to the inverter. The wheel loader also includes a ground engaging member drivably coupled to the electric motor. The wheel loader further includes a tank coupled to the frame. The tank includes at least one face of and is configured to receive the inverter thereon.

Other features and aspects of this disclosure will be apparent from the following description and the accompanying drawings.

### BRIEF DESCRIPTION OF THE DRAWINGS

FIG. 1 is a perspective view of an exemplary machine, according to an embodiment of the present disclosure;

FIG. 2 is a block diagram of an exemplary electric drive system, according to an embodiment of the present disclosure; and

FIG. 3 is a perspective view of a tank compartment of the machine, according to an embodiment of the present disclosure.

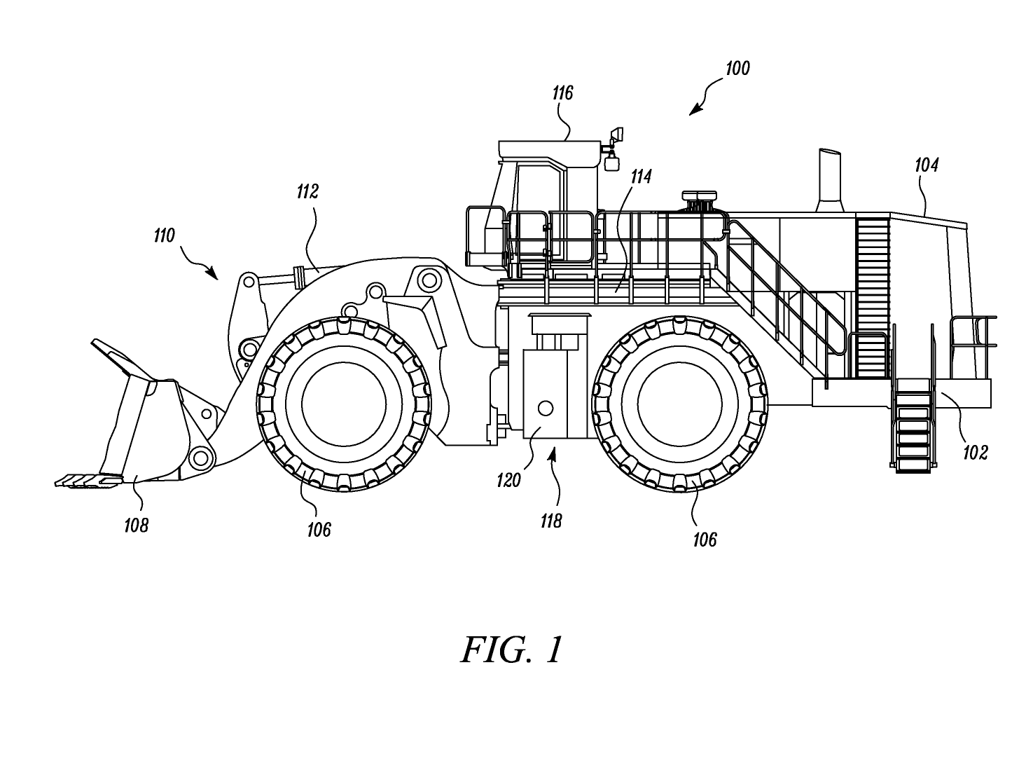

### DETAILED DESCRIPTION

Wherever possible, the same reference numbers will be used throughout the drawings to refer to the same or the like parts. Referring to FIG. 1, an exemplary machine 100 is illustrated. More specifically, the machine 100 is an electric wheel loader. In other embodiments, the machine 100 may be any other machine related to an industry such as construction, agriculture, forestry, transportation, material handling, waste management, and so on. Accordingly, the machine 100 may be an excavator, a crane, a dozer, a truck, and so on.

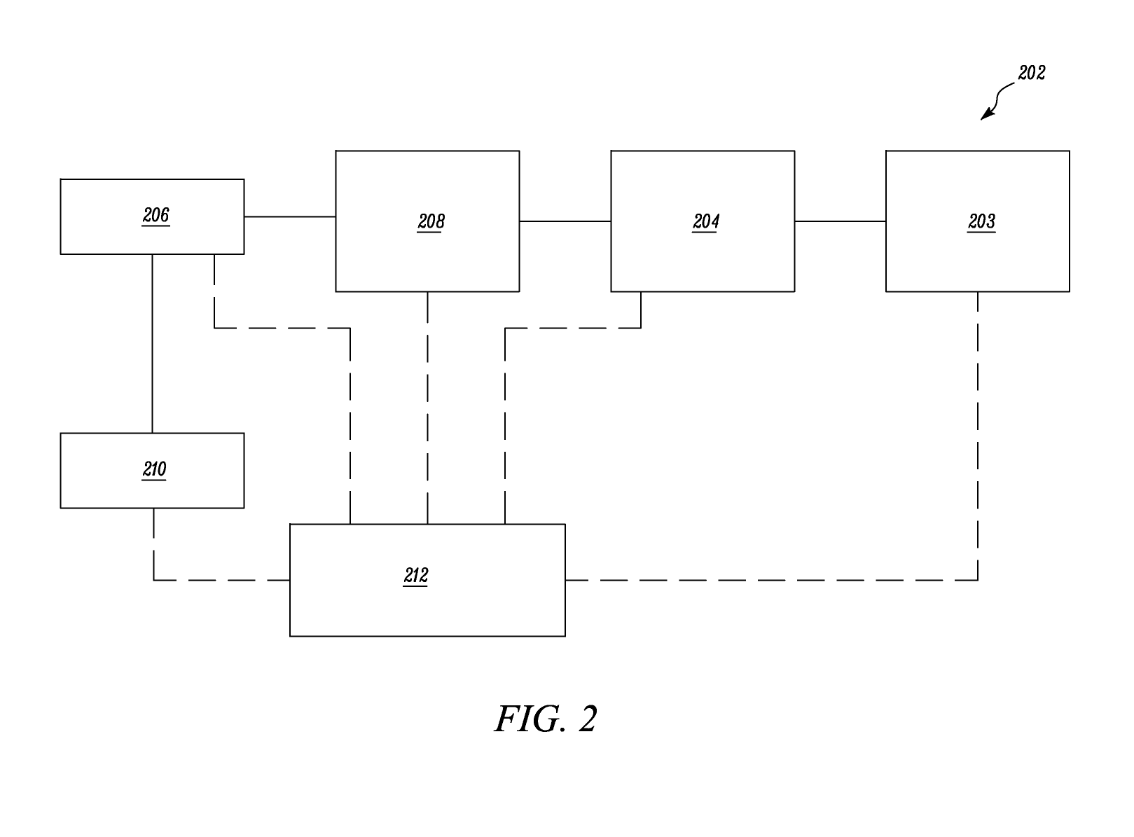

The machine 100 includes a frame 102. The frame 102 is configured to support and/or mount one or more components of the machine 100. The machine 100 includes an enclosure 104 provided on the frame 102. The enclosure 104 is configured to house an engine and/or an electric drive system 202 (shown in FIG. 2 and explained subsequently). The engine may be any power source known in the art such as, for example, an internal combustion engine. The engine provides power to the machine 100 for operational and mobility requirements. The machine 100 includes one or more ground engaging members 106 such as, wheels. The ground engaging members 106 are configured to provide mobility to the machine 100 on ground.

The machine 100 includes an implement 108 coupled to the frame 102 through a linkage assembly 110. The implement 108 may be any implement known in the art such as, a bucket. The implement 108 may be configured to transfer material such as, soil or debris, from one location to another. The linkage assembly 110 includes one or more cylinders 112 that are operated hydraulically or pneumatically. The cylinders 112 are configured to raise or lower the linkage assembly 110 and/or the implement 108 with respect to the frame 102 of the machine 100.

The machine 100 includes a platform 114 provided on the frame 102. The platform 114 provides access to various locations on the machine 100 for operational and/or maintenance purpose. The machine 100 includes an operator cabin 116 provided on the frame 102. The operator cabin 116 may be accessed via the platform 114. The operator cabin 116 may include one or more control devices (not shown) such as, a joystick, a steering wheel, pedals, levers, buttons, switches, and so on. The control device is configured to enable the operator to control the machine 100 on the ground and/or the implement 108 as per operational requirements. The operator cabin 116 may also include an operator interface such as, a display device, a sound source, a light source, or a combination thereof. The operator interface may provide information to the operator related to various machine parameters.

The machine 100 includes a tank compartment 118 provided on the frame 102. The tank compartment 118 includes a tank 120 coupled to the frame 102. The tank 120 is fluidly coupled to the engine. The tank 120 is configured to store a fuel therein and serve as a source for supply of the fuel to the engine. In other embodiments, the tank 120 may be fluidly coupled to other components of the machine 100 such as, a hydraulic system (not shown). Accordingly, the tank 120 may store a hydraulic fluid therein and supply the hydraulic fluid to the hydraulic system. The tank compartment 118 is configured to receive one or more components of the electric drive system 202 and will be explained later in detail.

Referring to FIG. 2, a block diagram of the exemplary electric drive system 202, hereinafter referred to as the electric drive 202, is illustrated. The electric drive 202 includes a generator 204. The generator 204 is drivably coupled to the engine 203. The generator 204 is configured to generate electrical power. The electric drive 202 includes an inverter 206 communicably connected to the generator 204. Additionally, the electric drive 202 may include a second inverter 210 communicably connected to the generator 204. The inverter and second inverter 206, 210 is further communicably connected to an electric motor 208 of the electric drive 202. The inverter 206 is configured to receive electrical power from the generator 204 and further supply the received electrical power to the electric motor 208. The electric motor 208 is drivably coupled to the ground engaging members 106. The electric motor 208 is configured to provide motive power to the ground engaging members 106 for mobility of the machine 100 on the ground. Additionally, the electric drive 202 may include a control system 212. The control system 212 is communicably connected to the engine 203, the generator 204, the electric motor 208, the inverter 206 and/or the second inverter 210. The control system 212 is configured to control and/or monitor one or more operational parameters of one or more connected components of the electric drive 202.

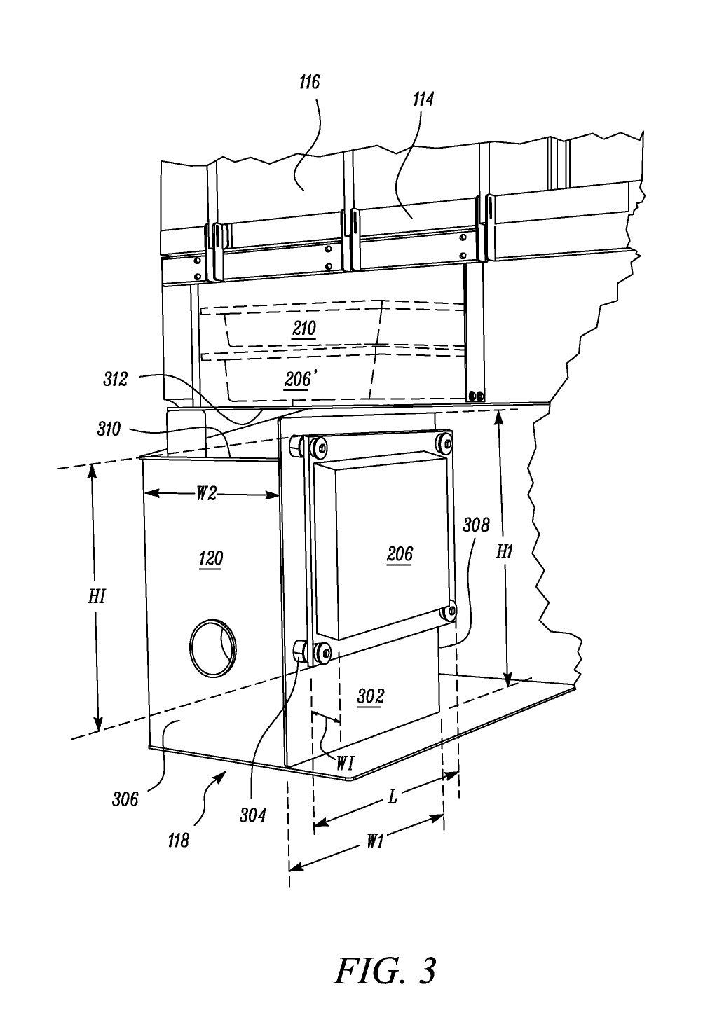

Referring to FIG. 3, an enlarged view of an exemplary tank compartment 118 of the machine 100 is illustrated. The tank 120 includes a first face 302 having a width “W1”. The first face 302 may receive the inverter 206 thereon. Additionally, the tank 120 and the inverter 206 are positioned below the platform 114. More specifically, the tank 120 and the inverter 206 are positioned on one side of the machine 100 and between the ground engaging members 106. In other embodiments, the tank 120 and the inverter 206 may be positioned at other locations on the machine 100 such as, for example, over the platform 114, on other side of the machine 100, within the enclosure 104, and so on.

The width “W1” of the first face 302 is approximately equal to or greater than a length “L” of the inverter 206 in order to accommodate the inverter 206 thereon and within the tank compartment 118. More specifically, the width “W1” of the first face 302 is increased in a manner such that the width “W1” is approximately equal to or greater than the length “L” of the inverter 206 in order to accommodate the inverter 206 thereon and within the tank compartment 118. In other embodiments, the width “W1” of the first face 302 may be reduced in a manner such that the width “W1” may be approximately equal to or greater than the length “L” of the inverter 206 in order to accommodate the inverter 206 thereon and within the tank compartment 118. The inverter 206 is releasably mounted on the first face 302 using one or more vibration isolation members 304. The vibration isolation member 304 may be any vibration isolation device known in the art, for example, a rubber pad, dampening mount, and so on. Further, the inverter 206 is mounted on the first face 302 such that the inverter 206 is substantially parallel to the first face 302.

The tank 120 includes a second face 306 and a third face 308 extending from the first face 302. Each of the second and third faces 306, 308 are positioned on an opposite end of the first face 302 in a manner such that the second and third faces 306, 308 are substantially parallel and opposite to one another. In other embodiments, the second and third faces 306, 308 may be inclined to one another and/or the first face 302. The second and third faces 306, 308 define widths “W2”, “W3” (not shown) respectively. The widths “W2”, “W3” of the second and third faces 306, 308 respectively are based on a width “W1” of the inverter 206. More specifically, the widths “W2”, “W3” of the second and third faces 306, 308 respectively are reduced to approximately be equal to the width “W1” of the inverter 206 in order to accommodate the inverter 206 within the tank compartment 118. Accordingly, the inverter 206 is positioned within the tank compartment 118 by reducing the widths “W2”, “W3” of the second and third faces 306, 308 respectively, and thereby reducing an overall size of the tank 120.

Further, in other embodiments, a height “HI” of the inverter 206 may be greater than a height “H1” of the first face 302. In such a situation, the height “H1” of the first face 302 may be increased so as to approximately be equal or greater than the height “HI” of the inverter 206 in order to accommodate the inverter 206 thereon and within the tank compartment 118. It should be noted that positioning of the inverter 206 within the tank compartment 118 is merely exemplary and may vary as per system design and configuration without limiting the scope of this disclosure. For example, the inverter 206 may be mounted on any other face of the tank 120. Accordingly, the respective face of the tank 120 may be sized based on dimensions of the inverter 206 in order to accommodate the inverter 206 within the tank compartment 118.

In other embodiments, the inverter 206′ (shown by ghost lines) may be alternatively or additionally positioned between a top surface 310 of the tank 120 and the platform 114 of the machine 100. The top surface 310 is defined by at least one of the first face 302, the second face 306, and the third face 308. Also, the top surface 310 is adjacent to the first, second and/or third faces 302, 306, 308 of the tank 120. More specifically, the inverter 206′ is releasably mounted on a mounting plate 312 coupled to the platform 114 and/or the frame 102 of the machine 100. The inverter 206′ is mounted in a manner such that the inverter 206′ is substantially parallel to the top surface 310. In other embodiments, the inverter 206, 206′ may be mounted on the tank compartment 118. Accordingly, the tank compartment 118 may be sized based on dimensions of the inverter 206, 206′ in order to accommodate the inverter 206, 206′ outside the tank compartment 118.

Additionally, the electric drive 202 may include the second inverter 210 (shown by ghost lines). In other embodiments, the electric drive 202 may include a single or multiple inverters based on a number of the generators 204, a number of the electric motors 208, or a rating or a power capacity of the electric drive 202. The second inverter 210 is positioned between the top surface 310 of the tank 120 and the platform 114 of the machine 100. More specifically, the second inverter 210 is provided on the inverter 206′ in a stacked arrangement. The second inverter 210 is mounted in a manner such that the second inverter 210 is substantially parallel to the top surface 310.

It should be noted that positioning of the second inverter 210 on the machine 100 is merely exemplary and may vary as per system design and configuration without limiting the scope of this disclosure. For example, in other embodiments, the second inverter 210 may be additionally or optionally provided on the inverter 206 provided on the first face 302 in a stacked arrangement. In yet other embodiments, the second inverter 210 may be mounted on at least one of the second and/or third faces 306, 308 and/or the top surface 310. For example, the inverter 206, 206′ may be provided on the first face 302 and the second inverter 210 may be mounted on at least one of the second and/or third faces 306, 308 and/or the top surface 310.

One of ordinary skill in the art will appreciate that the locations of the inverter 206, 206′ and the second inverter 210 described herein are exemplary and may not limit the scope of the present disclosure. The inverter 206, 206′ and the second inverter 210 may be mounted on any face of the tank 120. Accordingly, the respective face of the tank 120 may be sized based on dimensions of the inverter 206, 206′ and the second inverter 210 in order to accommodate the respective inverter within or external to the tank compartment 118.

### INDUSTRIAL APPLICABILITY

The machine powered by the electric drive may have improved fuel efficiency as compared to a conventional engine powered machine. The electric drive may require lower fuel consumption during operation of the machine. Accordingly, a size of the tank of the machine may be modified in order to store relatively smaller volume of the fuel when the electric drive system is installed on the machine. The reduced size of the tank may create space for installation of various components, for example, the inverter of the electric drive.

In order to install the electric drive 202 on the machine 100, the width “W1” of the first face 302 of the tank 120 may be increased based on the length “L” of the inverter 206, 206′. In other embodiments, the width “W1” of the first face 302 may be reduced based on the length “L” of the inverter 206, 206′. More specifically, the width “W1” the first face 302 may be sized based on the length “L” of the inverter 206, 206′ in order to accommodate the inverter 206, 206′ thereon and within the tank compartment 118.

The widths “W2”, “W3” of the second and third faces 306, 308 may be reduced based on the width “WI” of the inverter 206, 206′. More specifically, the widths “W2”, “W3” of the second and third faces 306, 308 respectively may be sized based on the width “WI” of the inverter 206, 206′ in order to accommodate the inverter 206, 206′ within the tank compartment 118. The inverter 206, 206′ may be mounted on the first face 302 using the vibration isolation members 304. The inverter 206, 206′ may be mounted substantially parallel to the first face 302.

Additionally, the second inverter 210 may be positioned between the top surface 310 of the tank 120 and the platform 114 of the machine 100. As explained above, the second inverter 210 may be provided in a stacked arrangement atop the inverter 206, 206′. The second inverter 210 may be mounted in a manner such that the second inverter 210 may be substantially parallel to the top surface 310 of the tank 120. In other embodiments, the second inverter 210 may be mounted on another face of the tank 120 or on the tank compartment 118 in order to accommodate the second inverter 210 either within or outside the tank compartment 118 respectively.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A machine comprising:
a frame;
an engine provided on the frame;
a generator drivably coupled to the engine;
an inverter communicably connected to the generator;
an electric motor communicably connected to the inverter; and
a tank coupled to the frame, the tank having at least one face and configured to receive the inverter thereon.

2. The machine of claim 1, wherein the tank is configured to store at least one of a fuel and a hydraulic fluid.

3. The machine of claim 1, wherein a width of the at least one face is equal to or greater than a length of the inverter.

4. The machine of claim 1, wherein the tank further defines a second face and a third face each positioned on an opposite end of the at least one face, and wherein widths of the second face and the third face are configured to receive the inverter thereon.

5. The machine of claim 4, wherein a one of the at least one face, the second face and the third face defines a top surface of the tank.

6. The machine of claim 4 further including a second inverter mounted to a one of the second face and the third face.

7. The machine of claim 5, wherein the inverter is positioned between the top surface of the tank and a platform coupled to the frame of the machine.

8. The machine of claim 1 further including a second inverter mounted on the inverter in a stacked arrangement.

9. The machine of claim 1, wherein the inverter is mounted parallel to the at least one face of the tank.

10. The machine of claim 1, wherein the tank and the inverter are positioned below a platform coupled to the frame of the machine.

11. A wheel loader powered by an electric drive system, the wheel loader comprising:
a frame;
an implement coupled to the frame;
an engine provided on the frame;
a generator drivably coupled to the engine;
an inverter communicably connected to the generator;
an electric motor communicably connected to the inverter;
a ground engaging member drivably coupled to the electric motor; and
a tank coupled to the frame, the tank having at least one face and configured to receive the inverter thereon.

12. The wheel loader of claim 11, wherein the tank is configured to store at least one of a fuel and a hydraulic fluid.

13. The wheel loader of claim 11, wherein a width of the at least one face is equal to or greater than a length of the inverter.

14. The wheel loader of claim 11, wherein the tank further defines a second face and a third face each positioned on an opposite end of the at least one face, and wherein widths of the second face and the third face are configured to receive the inverter thereon.

15. The wheel loader of claim 14, wherein a one of the at least one face, the second face and the third face defines a top surface of the tank.

16. The wheel loader of claim 14 further including a second inverter mounted to a one of the second face and the third face.

17. The wheel loader of claim 15, wherein the inverter is positioned between the top surface of the tank and a platform coupled to the frame of the machine.

18. The wheel loader of claim 11 further including a second inverter mounted on the inverter in a stacked arrangement.

19. The wheel loader of claim 11, wherein the inverter is mounted parallel to the at least one face of the tank.

20. The wheel loader of claim 11, wherein the tank and the inverter are positioned below a platform coupled to the frame of the machine.
